(19) United States
(12) Patent Application Publication
(10) Pub. No.: US 2003/0211776 A1
(43) Pub. Date: Nov. 13, 2003

(54) TERMINAL STRUCTURE AND STACKED AUDIO JACK CONNECTOR PROVIDED THEREWITH

(76) Inventor: Chien-Chung Lin, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/141,125

(22) Filed: May 9, 2002

(51) Int. Cl. H01R 13/60

(52) U.S. Cl. 439/541.5

(57) ABSTRACT

The present invention provides an terminal structure of an erect type stacked audio jack connector. The audio jack connector has at least two connector's main bodies. A first and a second signal terminal sets are disposed in each connector's main body. The first signal terminal set includes two first L-shaped terminals. A support portion is extended from one of the first L-shaped terminals. A bent elastic portion is extended from the support portion. A contact portion is extended from the elastic portion. A limit portion is extended from the other first L-shaped terminal. Similarly, the second signal terminal set includes two second L-shaped terminals. A support portion is extended from one of the second L-shaped terminals. A bent elastic portion is extended from the support portion. A contact portion is extended from the elastic portion. A limit portion is extended from the other second L-shaped terminal.

### FIELD OF THE INVENTION

The present invention relates to an terminal structure of an erect type stacked audio jack connector and, more particularly, to a terminal structure applied in an audio jack connector, which is formed by erectly stacking and fixedly joining at least two connector.

### BACKGROUND OF THE INVENTION

Along with continual development of various kinds of electronic products and multimedia techniques, audio jack connectors have been widely applied in various kinds of industries. Stacked audio jack connectors come with the tide of fashion for expansion of peripherals of various kinds of electronic products.

As shown in FIGS. 1 and 2, a prior art stacked audio jack connector is formed by stacking and fixedly joining a plurality of connector's main bodies 1a. A hollow cylindrical plug portion 10a projects from the front side face of each of the connector's main bodies 1a. The hollow portion of the plug portion 10a forms a circular plug hole 11a, which is extended to the inside of the connector's main body 1a for insertion of an audio jack connector (not shown). Besides, five transversally arranged thin trenches 12a are disposed in the connector's main body 1a. The middle trench 12a is used for insertion of a ground terminal 13a, which is erectly plugged at the rear side face of the connector's main body 1a. The four trenches 12a at the left and right sides of the connector's main body 1a are used for insertion of a first signal terminal set 14a and a second signal terminal set 15a. Both the first and second signal terminal sets 14a and 15a comprise two L-shaped terminal 16a and an elastic clamping piece 17a clamped at the front end portion of the two L-shaped terminals 16a. A contact portion 18a is further formed on the elastic clamping piece 17a to contact an inserted audio jack connector (not shown).

Because the elastic clamping pieces 17a and the L-shaped terminals 16a of the above first and second signal terminal sets 14a and 15a are separately formed and then assembled together, additional complicated manufacturing procedures are required. Moreover, when the elastic clamping piece 17a is clamped on the two L-shaped terminals 16a, complete contact of plane to plane cannot be assured between them, hence influencing signal transmission of connector. Furthermore, the terminal structure assembled in this way cannot effectively shrink its volume, hence being difficult to meet the requirement of compactness in today's market.

Accordingly, the above terminal structure of stacked audio jack connector has drawbacks and inconvenience in practical use. The present invention aims to provide an terminal structure of an erect type stacked audio jack connector to resolve the problems in the prior art.

### SUMMARY OF THE INVENTION

The primary object of the present invention is to provide an terminal structure of an erect type stacked audio jack connector. The terminal structure is integrally formed to be firmer and have good rigidity and better contact elasticity. Simultaneously, the impedance generated when plugging with an audio jack connector can be reduced. Moreover, the terminal structure can maintain good contact and will not fall off even under the situation of large vibration.

To achieve the above object, the present invention provides an terminal structure of an erect type stacked audio jack connector. The audio jack connector has at least two connector's main bodies. Five trenches are disposed in each of the connector's main bodies. The middle trench is used to plug with a ground terminal, which is plugged at the rear side face of the connector's main body. The other four trenches at the left and right sides of each of the connector's main bodies are used for insertion of a first signal terminal set and a second signal terminal set. The present invention is characterized in that the integration way of the first and second signal terminal sets is improved. The first signal terminal set comprises two first L-shaped terminals arranged side by side, which are inserted into the left two trenches of the connector's main body. A support portion is extended from the front end portion of one of the first L-shaped terminals. A bent elastic portion is extended from the support portion. A contact portion is further extended from the elastic portion. A limit portion abutting against the boundary between the elastic portion and the contact portion is extended from the front end portion of the other first L-shaped terminal. Similarly, the second signal terminal set comprises two second L-shaped terminals arranged side by side, which are inserted into the right two trenches of the connector's main body. A support portion is extended from the front end portion of one of the second L-shaped terminals. A bent elastic portion is extended from the support portion. A contact portion is further extended from the elastic portion. A limit portion abutting against the boundary between the elastic portion and the contact portion is extended from the front end portion of the other second L-shaped terminal.

The various objects and advantages of the present invention will be more readily understood from the following detailed description when read in conjunction with the appended drawing, in which:

### BRIEF DESCRIPTION OF THE DRAWINGS

FIG. 1 is a perspective view of a prior art stacked audio jack connector;

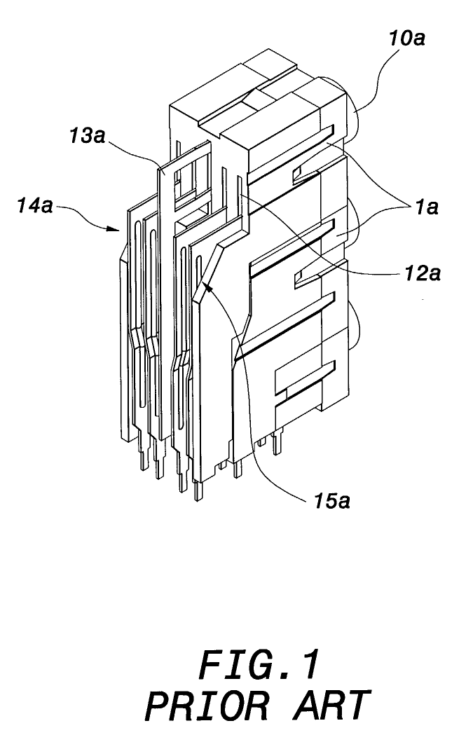

FIG. 2 is a partly exploded perspective view of a prior art stacked audio jack connector;

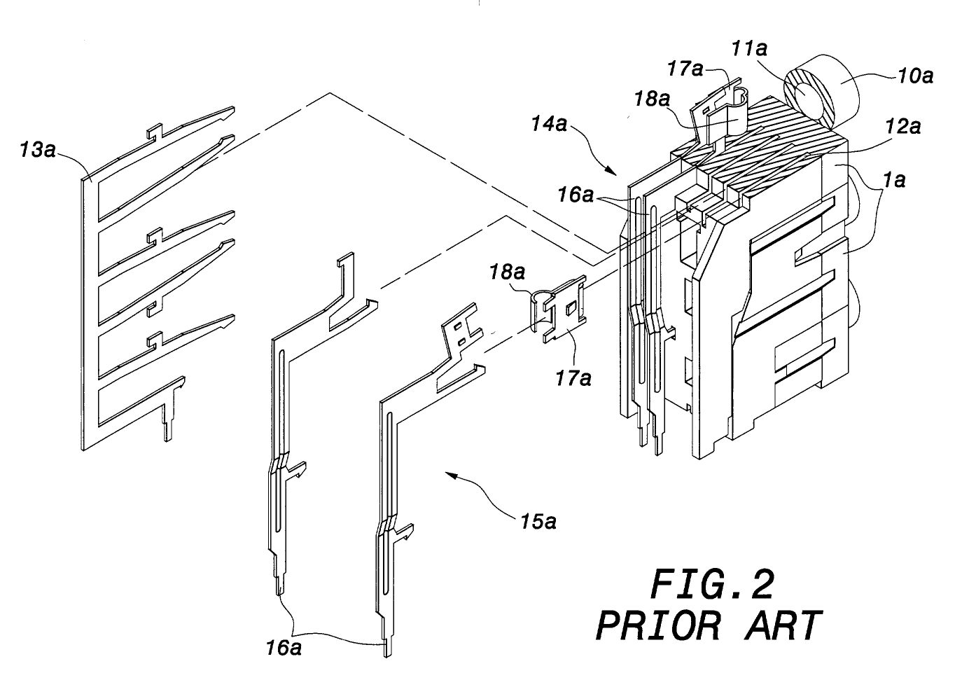

FIG. 3 is a perspective view of the present invention;

FIG. 4 is a partly exploded perspective view of the present invention; and

FIG. 5 is a partly perspective assembly view of the present invention.

### DETAILED DESCRIPTION OF THE PREFERRED EMBODIMENTS

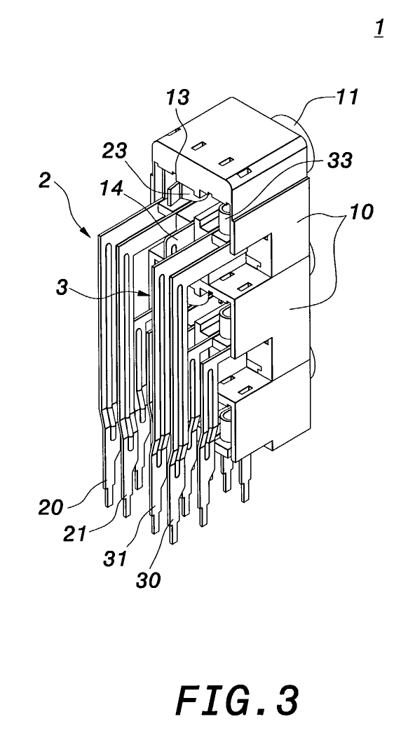

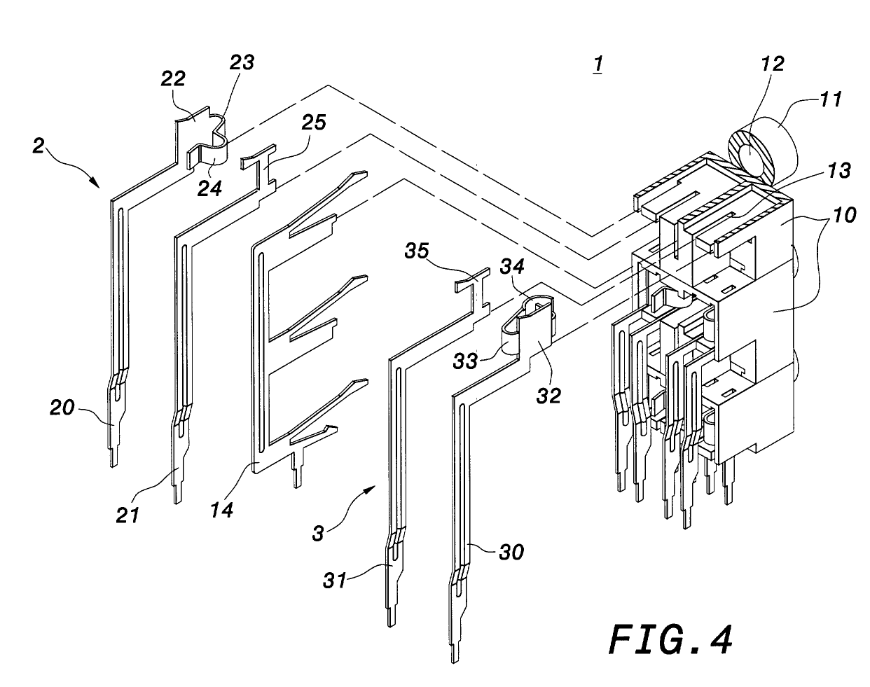

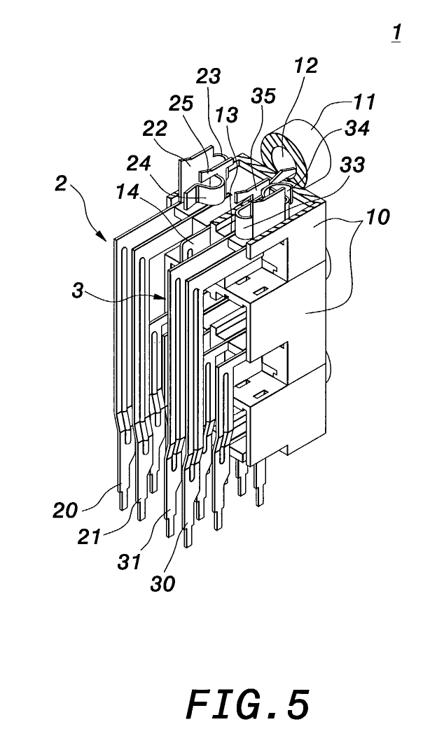

As shown in FIGS. 3, 4, and 5, the present invention provides an terminal structure of an erect type stacked audio jack connector. The terminal structure applies to an audio jack connector 1 formed by erectly stacking and fixedly joining at least two connector's main bodies 10. A hollow cylindrical plug portion 11 projects from the front side face of each of the connector's main bodies 10 of the audio jack connector 1. The hollow portion of the plug portion 11 forms a circular plug hole 12, which is extended to the inside of the connector's main body for insertion of an audio jack connector (not shown).

Five transversally arranged thin trenches 13 are disposed in each of the connector's main bodies 10. The middle trench 13 is used for insertion of a ground terminal 14, which is erectly plugged at the rear side face of the connector's main body 10. The other four trenches 13 at left and right sides of each of the connector's main bodies 10 are used for insertion of a first signal terminal set 2 and a second signal terminal set 3.

The present invention is characterized in that the integration way of the first and second signal terminal sets 2 and 3 is improved.

The first signal terminal set 2 comprises two first L-shaped terminals 20 and 21 arranged side by side, which are inserted into the left two trenches 13 of the connector's main body 10. A square support portion 22 is extended from the front end portion of one of the first L-shaped terminals 20. An elastic portion 23 bent toward the ground terminal 14 is extended from the front end of the support portion 22. The distal end of the elastic portion 23 forms a contact portion 24 to contact an inserted audio jack connector (not shown). An I-shaped limit portion 25 abutting against the boundary between the elastic portion 23 and the contact portion 24 is extended upwards from the front end portion of the other first L-shaped terminal 21.

Similarly, the second signal terminal set 3 comprises two second L-shaped terminals 30 and 31 arranged side by side, which are inserted into the right two trenches 13 of the connector's main body 10. A square support portion 32 is extended from the front end portion of one of the second L-shaped terminals 30. An elastic portion 33 bent toward the ground terminal 14 is extended from the rear end of the support portion 32. The distal end of the elastic portion 33 forms a contact portion 34 to contact an inserted audio jack connector (not shown). An I-shaped limit portion 35 abutting against the boundary between the elastic portion 33 and the contact portion 34 is extended upwards from the front end portion of the other second L-shaped terminal 31.

In the terminal structure of an erect type stacked audio jack connector of the present invention, because the first and second L-shaped terminals 20 and 30 are integrally formed with the support portions 22 and 32, the elastic portions 23 and 33, and the contact portions 24 and 34, respectively, the terminal structure of the audio jack connector 1 is firmer and has good rigidity and better contact elasticity. Simultaneously, the impedance generated when plugging with an audio jack connector (not shown) can be reduced. Moreover, the terminal structure can maintain good contact and will not fall off even under the situation of large vibration.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An terminal structure of an erect type stacked audio jack connector, said audio jack connector having at least two connector's main bodies, five trenches being disposed in each of said connector's main bodies, the middle one of said trenches being used for insertion of a ground terminal, which is plugged at a rear side face of each of said connector's main bodies, the other four of said trenches at left and right sides of each of said connector's main bodies being used for insertion of a first signal terminal set and a second signal terminal set, said first signal terminal set comprising two first L-shaped terminals arranged side by side, which are inserted into the left two of said trenches of said connector's main body, a support portion being extended from a front end portion of one of said first L-shaped terminals, a bent elastic portion being extended from said support portion, a contact portion being further extended from said elastic portion, a limit portion abutting against the boundary between said elastic portion and said contact portion being extended from a front end portion of the other said first L-shaped terminal, the second signal terminal set comprising two second L-shaped terminals arranged side by side, which are inserted into the right two of said trenches of said connector's main body, a support portion being extended from a front end portion of one of said second L-shaped terminals, a bent elastic portion being extended from the support portion, a contact portion being further extended from said elastic portion, a limit portion abutting against the boundary between said elastic portion and said contact portion being extended from a front end portion of the other said second L-shaped terminal.

2. The terminal structure of an erect type stacked audio jack connector as claimed in claim 1, wherein said support portions of said first and second signal terminal sets are extended upwards.

3. The terminal structure of an erect type stacked audio jack connector as claimed in claim 1, wherein said elastic portions of said first and second signal terminal sets are bent toward said ground terminal.
